(19) United States
(12) Patent Application Publication
(10) Pub. No.: US 2023/0357521 A1
(43) Pub. Date: Nov. 9, 2023

(54) PROCESS FOR CHEMICALLY MODIFYING A SPECIFIC POLYMERIC PART IN ORDER TO IMPART FLAME RETARDANT PROPERTIES THERETO OR TO IMPROVE THESE PROPERTIES

(71) Applicant: COMMISSARIAT À L'ÉNERGIE ATOMIQUE ET AUX ÉNERGIES ALTERNATIVES, Paris (FR)

(72) Inventors: Aurélien Auger, Grenoble (FR); Jérémie Auvergniot, Grenoble (FR); Jérôme Delmas, Grenoble (FR); Isabelle Rougeaux, Grenoble (FR)

(21) Appl. No.: 18/041,164

(22) PCT Filed: Aug. 5, 2021
(86) PCT No.: PCT/FR2021/051442

§ 371 Date: Feb. 9, 2023

(30) Foreign Application Priority Data
Aug. 10, 2020 (FR) 2008402

(51) Int. Cl. C08J 7/06; C08J 7/16

(52) U.S. Cl. CPC C08J 7/065; C08J 7/16; C08J 2377/02

(57) ABSTRACT

A process for chemically modifying a polymeric part in order to provide it with flame retardancy properties or to enhance the properties, the process comprising a step of reacting at least one polymeric part comprising at least one polymer of which the reactive groups comprise amine groups and/or hydroxyl groups with a flame retardant compound comprising at least one group that reacts, by nucleophilic substitution or nucleophilic addition, with some or all of the amine groups and/or hydroxyl groups of the polymer or polymers, the reaction being carried out with the compound in gaseous form.

### TECHNICAL FIELD

The present invention relates to a process for chemically modifying a specific polymeric part in order to impart flame retardant properties thereto or to improve these properties, said process involving a covalent reaction with at least one flame retardant compound.

Conventionally, the flame retardant properties of a polymeric part can be modified or improved in different manners, such as for example:
the addition of one or more organic or inorganic flame retardant fillers in the polymer powder before the formation of a composite material (for example, by extrusion, spinning, melting, thermoforming), with however the possibility that the presence of fillers has a negative effect on the properties of the polymer which are not desired to be modified, especially as, in order to be effective, the fillers must be present at a mass content which is greater than 30%; or
the impregnation of the polymer with one or more chemical agents allowing imparting or improving the targeted property with however the following drawback(s):
   * the impregnation results only in a surface treatment and does not allow reaching the part in depth, the targeted property thus only being located on the surface of the part;
   * the impregnation does not allow a strong attachment of the chemical agent(s), the targeted property imparted by this or these agents not having satisfactory resistance over time.

In view of the above, the authors of the present invention have proposed to develop a process for modifying a polymeric part in order to impart flame retardant properties thereto or to improve these properties which does not have the limitations of the processes mentioned below.

### DISCLOSURE OF THE INVENTION

Thus, the invention relates to a process for chemically modifying a polymeric part in order to impart flame retardant properties thereto or to improve these properties, said process comprising a step of reacting a polymeric part comprising at least one polymer comprising, as reactive groups, amine groups and/or hydroxyl groups, with a flame retardant compound comprising at least one group reacting, by nucleophilic substitution or nucleophilic addition, with some or all of the amine groups and/or hydroxyl groups of the polymer(s), the reaction being implemented with said compound in gaseous form.

By polymeric part, it is specified that it is, conventionally, a part made of a material comprising at least one polymer comprising, as reactive groups, amine groups and/or hydroxyl groups, said polymer(s) being in the form of the part, for example, by a shaping technique, such as the 3D printing technique, the extrusion/injection technique, the additive manufacturing technique, the process of the invention can thus be part of the manufacturing cycle of a part at the “post-process” stage (that is to say the finishing stage of the part after its shaping).

The term “flame retardant compound” means a compound capable of imparting flame retardant properties.

Thanks to the reaction involving a flame retardant compound in gaseous form to chemically modify the polymeric part, the following advantages have been identified:
the improvement of the flame retardant properties of the polymeric part, regardless of the shaping technique which allowed obtaining the part, without impacting the shape, the geometry and the finishing details of the polymeric part;
the possibility of carrying out said modification by limiting the used amount of flame retardant compound(s) (for example, less than 5 mass %);
the possibility of minimising the used amount of flame retardant compound(s) and of functionalising, if necessary, all complex reliefs of the part;
the attachment of the flame retardant compound(s), in a robust manner, because the functionalisation of the polymeric part by this or these compounds consists of a chemical grafting of the part by this or these compounds;
the versatile nature of the process, which allows the functionalisation of part(s) regardless of the geometry of the part(s) and the level of details.

Moreover, the process of the invention can have the following advantages:
a process which can be easily industrialised including a small number of steps, generally, not requiring large amounts of products and allowing the simultaneous treatment of several parts;
no prior preparation of the surface of the parts to be treated
the possibility of treating all complex reliefs of the parts, if necessary.

As mentioned above, the process of the invention comprises a step of reacting a polymeric part comprising at least one polymer comprising, as reactive groups, amine groups and/or hydroxyl groups, with a flame retardant compound comprising at least one group reacting, by nucleophilic substitution or nucleophilic addition, with some or all of the amine groups and/or hydroxyl groups of the polymer(s), said compound being in gaseous form under the reaction conditions.

The polymeric part intended to be treated in accordance with the process of the invention is a part comprising (or even consisting exclusively of) at least one polymer comprising, as reactive groups, amine groups and/or hydroxyl groups, the amine and/or hydroxyl groups reacting, covalently, by nucleophilic substitution or nucleophilic addition with the flame retardant compound(s).

In particular, the polymeric part intended to be treated in accordance with the process of the invention may be a part comprising (or even consisting exclusively of) one or more polyamides and, even more specifically, the polymeric part can be a polyamide-12 part, the reactive groups being, in this case, amine groups. More specifically, the part can be made of porous or partially porous polyamide-12 and, even more specifically, a polyamide-12 having a density which is less than or equal to 960 kg/m³, for example ranging from 650 kg/m³ to 960 kg/m³, preferably less than or equal to 900 kg/m³, for example ranging from 700 kg/m³ to 900 kg/m³.

The flame retardant compound(s) comprise at least one group reacting, by nucleophilic substitution or nucleophilic addition, with some or all of the amine groups and/or hydroxyl groups of the polymer(s), this or these groups can be:
nucleofuge groups, when the reaction step is a nucleophilic substitution reaction step, and more specifically, halogen atoms, such as chlorine;
electrophilic groups, when the reaction step is a nucleophilic addition reaction step, such as epoxy groups, anhydride groups,

it being understood that the amine groups and/or the hydroxyl groups constitute nucleophilic groups reacting with nucleofuge groups, in the case of a nucleophilic substitution reaction, or reacting with the electrophilic groups, in the case of a nucleophilic addition reaction.

The flame retardant compound(s) advantageously comprise at least one group comprising at least one phosphorus atom, at least one sulphur atom and/or at least one silicon atom, which constitutes the functional group of interest since it is capable of imparting flame retardant properties to the polymeric part.

More specifically, when the reaction step is a nucleophilic substitution reaction step, the flame retardant compound(s) can be selected from the following compounds:
chloride compounds comprising an —SO₂— group;
chloride compounds comprising at least one —PO— group; and/or
chloride compounds comprising at least one —PS— group.

The chloride compounds comprising at least one —SO₂— group can further comprise a group comprising at least one heteroatom selected from N, O, Si or P, such as the following specific compounds: trimethylsilyl chlorosulfonate, (2-trimethylsilyl)ethanesulfonyl chloride.

The chloride compounds comprising at least one —PO— group can further comprise a hydrocarbon, aliphatic or aromatic group and/or a group comprising at least one heteroatom selected from N, O, Si or P.

Specific compounds comprising at least one —PO— group can be selected from:
diphosphoryl chloride of formula Cl₂P(O)OP(O)Cl₂;
N,N,N′,N′-tetramethylphosphorodiamidic chloride of formula I(CH₃)₂N]₂P(O)CI;
phenyl dichlorophosphate of formula C₆H₅OP(O)Cl₂; or
2-chloro-1,3,2-dioxaphospholane-2-oxide (CAS number: 6609-64-09).

The chloride compounds comprising at least one —PS— group can further comprise a hydrocarbon, aliphatic or aromatic group and/or a group comprising at least one heteroatom selected from N, O, Si or P, such as O,O′-diethyl methylphosphonothioate (CAS number: 6996-81-2).

More specifically, when the reaction step is a nucleophilic addition reaction step, the flame retardant compound(s) can be selected from:
epoxy compounds comprising at least one pendant group comprising at least one heteroatom selected from N, O, Si or P;
phosphorus anhydride compounds; and/or
cyclic siloxane compounds.

Among the conventional siloxane compounds, mention may be made of hexamethylcyclotrisiloxane.

The flame retardant compound(s) react in the gaseous state with the polymeric part, which means that they are capable of existing in this gaseous state under the reaction conditions. More specifically, the flame retardant compound(s) may have a boiling point that can be reached under the following temperature and pressure conditions: a temperature which is less than or equal to 145° C. and a pressure which is greater than or equal to 10 mbar.

In particular, when the flame retardant compound(s) are chloride compounds comprising at least one —PO— group, such as diphosphoryl chloride, the reaction step can be carried out at a temperature ranging from 140 to 145° C. and a pressure ranging from 40 to 45 mbar.

When the flame retardant compound(s) are chloride compounds comprising at least one —SO₂— group, such as trimethylsilyl chlorosulfonate, the reaction step can be carried out at a temperature ranging from 115 to 120° C. and a pressure ranging from 30 to 35 mbar.

The reaction step is advantageously carried out exclusively in the presence of the polymeric part and the flame retardant compound(s) and, in particular, in the absence of organic solvent(s).

The reaction step is carried out at a temperature and a pressure necessary to maintain the flame retardant compound(s) in the gaseous state and to the reaction between the flame retardant compound(s) and the polymer(s) of the polymeric part.

More specifically, the reaction step can include the following operations:
an operation of placing, in a first reactor, the polymeric part, the reactor being heated to the temperature for implementing the process;
an operation of pressurising the reactor to the pressure for implementing the process;
an operation of vaporising the flame retardant compound(s) in a second reactor connected to the first reactor;
an operation of injecting the flame retardant compound(s) in the gaseous state into the first reactor;
an operation of maintaining the temperature and the pressure for implementing the process until the reaction is complete.

At the end of the reaction step, the polymeric parts are thus chemically modified and are covalently bonded to (or covalently grafted by) residues of the flame retardant compound(s) (the residues being what remains after it(they) has(have) reacted with the amine groups and/or hydroxyl groups of the polymer(s) of the polymeric part).

The reaction step can be implemented in a reactor, for example, of the autoclave type, comprising an enclosure intended to receive the polymeric part and the flame retardant compound(s), means for regulating the pressure of said enclosure for creating a vacuum therein (for example, via a vacuum pump communicating with the enclosure) and heating means.

After the reaction step, the polymeric part thus modified can, advantageously, then be subjected to a drying, for example, by heating or under vacuum and more specifically, to a heat treatment step which can be qualified as a heat treatment step of finishing the part, which allows homogenising the surface functionalisation of the part and thus imparting optimal fire retardant properties thereto.

In particular, the heat treatment step can comprise the following operations:
an operation of removing the part of the reactor where the reaction step took place;
an operation of transferring said part into an oven;
a step of heating said part to a temperature which can range from 50° C. to 140° C., more specifically from 80° C. to 130° C. and even more specifically from 100° C. to 120° C. for a period which can range from 1 hour to 24 hours, more specifically from 5 hours to 20 hours and even more specifically from 8 hours to 12 hours.

It is understood that the temperature and the duration will be selected so as not to alter the polymeric part.

Other advantages and features of the invention will appear in the nonlimiting detailed description below.

### BRIEF DESCRIPTION OF DRAWINGS

FIG. 1 is a diagram illustrating a device for implementing the process of the invention.

### DETAILED DISCLOSURE OF PREFERRED EMBODIMENTS

### Example 1

This example illustrates the implementation of a specific mode of the chemical modification process of the invention consisting of a chemical modification of a polyamide-12 part, so as to improve the flame retardant properties thereof by a flame retardant compound: diphosphoryl chloride of formula (Cl₂P(O)OP(O)Cl₂).

This flame retardant compound was selected because it has vaporisation conditions in line with the properties of polyamide-12, in particular relative to its melting temperature. Indeed, the boiling temperature of diphosphoryl chloride is 214° C. at 1 bar, i.e. 140° C. for an absolute pressure of 130 mbar.

The reaction of polyamide-12 with the flame retardant compound mentioned above can be represented by the following reaction scheme:

the other chlorine atoms can also be involved in a nucleophilic substitution

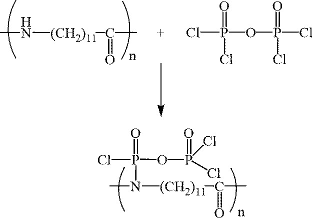

reaction with other —NH groups of the polyamide-12.

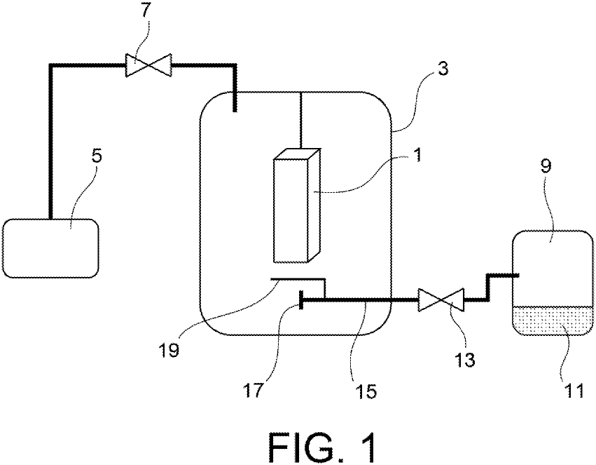

The process has been implemented in a device schematically illustrated in the appended FIG. 1.

The polyamide-12 sample to be treated (reference 1) is suspended in the deposition reactor 3, sealed and with magnetic stirring, previously heated to the treatment temperature then the latter is pressurised by vacuum drawing up to 40 mbar thanks to the vacuum pump 5 by opening the valve 7. Once the desired pressure has been obtained, the valve 7 is closed in order to maintain the deposition reactor 3 under vacuum and isolated.

In an adjacent reactor 9 which is connected to the deposition reactor 3, a known amount of flame retardant compound 11 is injected, at a temperature such that the latter is preheated or even in the gaseous state in order to facilitate its vaporisation.

When the temperature and pressure conditions allow maintaining the flame retardant compound in its vapour form, then the valve 13 between the deposition reactor 3 and the adjacent reactor 9 is opened. This is followed by the vaporisation of the compound in the conduit 15 inserted into deposition reactor 3 and thanks to the pressure difference between the two reactors 3 and 9.

The flame retardant compound is then inserted into the deposition reactor 3 via an injection nozzle 17 connected to the pipe 15. A plate 19 forming a physical barrier is located above the injection nozzle 17 to prevent any liquid projection of the flame retardant compound on the sample to be treated. The reaction (possibly its condensation) between the flame retardant compound and the sample to be treated thus takes place.

At the end of the duration of the process (from 1 to 30 minutes), purge cycles are performed in the reactor in order to recover the excess of the flame retardant compound which has not reacted. The pressure is released, then the treated sample is removed and placed in the oven (5 minutes to 1 hour), in order to completely eliminate the flame retardant compound which has not reacted.

More specifically, three tests were carried out with the operating conditions listed in the table below.

| Test | Temperature in the deposition reactor (in °C) | Pressure in the deposition reactor (in mbar) | Contact time (in min) | Loading rate (in mg) | Loading rate (in mass %) |
|---|---|---|---|---|---|
| 1 | 140-145 | 40-45 | 6 | 10 | 0.1 |
| 2 | 140-145 | 40-45 | 15 | 200 | 2.5 |
| 3 | 140-145 | 40-45 | 30 | 360 | 4.5 |

For accuracy, the loading rate (in mg) corresponds to the amount of flame retardant compound deposited on the sample, while the loading rate loading rate (in mass %) corresponds to the mass ratio of the amount of flame retardant compound deposited on the total mass of the sample after treatment.

For these different tests, characterisation by spectroscopic analysis (XPS and ToF SIMS) of the treated samples has allowed highlighting and confirming the formation of covalent bonds between the polymer and the flame retardant compound. Indeed, there is a modification of the XPS spectrum of the element N obtained on the treated polyamide-12. The complementary ToF-SIMS analyses confirmed the formation of —NP(O)— groups.

Consequently, these characterisations confirm that this post-treatment does not constitute a simple surface deposition. This is truly a covalent chemical grafting of the flame retardant compound onto the PA-12. This feature then makes the deposition much more robust. Its adherence relative to PA-12 is then very strong.

For these different tests, flame tests were also carried out to determine whether the samples originating from these tests (having a length of 125 mm, a width of 13 mm and a thickness of 5 mm) belong to the fire classes V-0, V-1, V-2 according to a representative test of the UL94V standard. Under multiple ignition, both the residual combustion and afterglow time and the casting of ignited drops from the sample are evaluated for this purpose.

The results obtained correspond to a V-0, namely the results:
a residual combustion time after ignition of less than 10 seconds;
a residual combustion time after the second ignition of less than 10 seconds;
no casting of ignited drops;
no complete combustion of the samples.

Moreover, a comparative fire test was carried out with:
a polyamide-12 part treated with diphosphoryl chloride in accordance with the protocol defined above (with a loading rate of 140 mg, i.e. 1.7 mg);
an untreated polyamide-12 part.

On observation, it appears that, unlike the untreated part, the treated part reveals very low ignition times (or even zero) during the 2 ignitions. In addition, no glowing drop likely to ignite the cotton was observed with the treated part.

### Example 2

This example illustrates the implementation of a specific mode of the chemical modification process of the invention consisting of a chemical modification of a polyamide-12 part, so as to improve the flame retardant properties thereof by a flame retardant compound: trimethylsilyl chlorosulfonate.

This flame retardant compound was selected because it has vaporisation conditions in line with the properties of polyamide-12, in particular relative to its melting temperature. Indeed, its vaporisation conditions are 80° C. at 50 mbar, 95° C. at 100 mbar or even 120° C. at 250 mbar.

The reaction of polyamide-12 with the flame retardant compound mentioned above can be represented by the following reaction scheme:

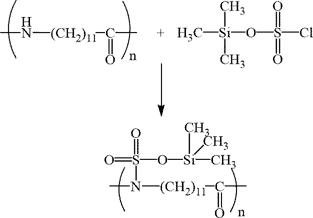

Thus, the trimethylsilyl chlorosulfonate is grafted onto the surface of the PA-12 part by forming covalent bonds. This reaction is accompanied by the formation of HCI.

More specifically, seven tests were carried out according to a process similar to that set out in Example 1, with the specific operating conditions listed in the table below.

| Test | Post-treatment conditions | | | Sample mass (g) | | Loading rate | |
|---|---|---|---|---|---|---|---|
| | T(°C) | P (mbar) | Time (min) | Before treatment | After treatment | mg | m % |
| 1 | 115-120 | 30-35 | 2 | 7.9296 | 7.974 | 44 | 0.5 % |
| 2 | | | | 8.0288 | 8.1157 | 87 | 1.1 % |
| 3 | | | | 8.0754 | 8.1651 | 90 | 1.1 % |
| 4 | | | | 7.9849 | 8.1067 | 122 | 1.5 % |
| 5 | | | 5 | 7.9711 | 8.1102 | 139 | 1.7 % |
| 6 | | | 10 | 7.6869 | 7.8422 | 155 | 1.9 % |
| 7 | | | | 7.963 | 8.1064 | 143 | 1.8 % |

For accuracy, the loading rate (in mg) corresponds to the amount of flame retardant compound deposited on the sample, while the loading rate (in mass %) corresponds to the mass ratio of the amount of flame retardant compound deposited on the total mass of the sample after treatment.

The flame tests described in Example 1 and performed (test representative of the UL94V standard) on the polyamide-12 parts treated with trimethylsilyl chlorosulfonate revealed that the grade VO was obtained according to the UL94V standard.

Moreover, the test was carried out on a sample having a loading rate of 85 mg i.e. 1.1 m%. It then appears that even with a low loading rate, the ignition times are zero and no glowing drop is formed.

What is claimed is:

1-14. (canceled)

15. A process for chemically modifying a polymeric part in order to impart flame retardant properties thereto or to improve these properties, said process comprising a step of reacting a polymeric part comprising at least one polymer comprising, as reactive groups, amine groups and/or hydroxyl groups, with a flame retardant compound comprising at least one group reacting, by nucleophilic substitution or nucleophilic addition, with some or all of the amine groups and/or hydroxyl groups of the polymer(s), the reaction being implemented with said compound in gaseous form.

16. The chemical modification process according to claim 15, wherein the polymeric part is a part comprising one or more polyamides.

17. The chemical modification process according to claim 15, wherein the polymeric part is a polyamide-12 part.

18. The chemical modification process according to claim 15, wherein the group(s) of the flame retardant compound(s) reacting, by nucleophilic substitution or nucleophilic addition, with some or all of the amine groups and/or hydroxyl groups of the polymer(s), are selected from:
nucleofuge groups, when the reaction step is a nucleophilic substitution reaction step;
electrophilic groups, when the reaction step is a nucleophilic addition reaction step.

19. The chemical modification process according to claim 15, wherein the flame retardant compound(s) comprise at least one group comprising at least one phosphorus atom, at least one sulphur atom and/or at least one silicon atom.

20. The chemical modification process according to claim 15, wherein, when the reaction step is a nucleophilic substitution reaction step, the flame retardant compound(s) are selected from the following compounds:
chloride compounds comprising an —SO₂— group;
chloride compounds comprising at least one —PO— group; and/or
chloride compounds comprising at least one —PS— group.

21. The chemical modification process according to claim 20, wherein the chloride compounds comprising at least one —SO₂— group further comprise a group comprising at least one heteroatom selected from N, O, Si or P.

22. The chemical modification process according to claim 20, wherein the chloride compounds comprising at least one —SO₂— group are selected from trimethylsilyl chlorosulfonate or (2-trimethylsilyl)ethanesulfonyl chloride.

23. The chemical modification process according to claim 20, wherein the chloride compounds comprising at least one —PO— group further comprise a hydrocarbon, aliphatic or aromatic group and/or a group comprising at least one heteroatom selected from N, O, Si or P.

24. The chemical modification process according to claim 20, wherein the chloride compounds comprising at least one —PO— group are selected from:
diphosphoryl chloride of formula Cl₂P(O)OP(O)Cl₂;
N,N,N′,N′-tetramethylphosphorodiamidic chloride of formula [(CH₃)₂N]₂P(O)Cl;
phenyl dichlorophosphate of formula C₆H₅OP(O)Cl₂; or
2-chloro-1,3,2-dioxaphospholane-2-oxide.

25. The chemical modification process according to claim 20, wherein the chloride compounds comprising at least one —PS— group further comprise a hydrocarbon, aliphatic or aromatic group and/or a group comprising at least one heteroatom selected from N, O, Si or P.

26. The chemical modification process according to claim 15, wherein, when the reaction step is a nucleophilic addition reaction step, the flame retardant compound(s) are selected from the following compounds:
epoxy compounds comprising at least one pendant group comprising at least one heteroatom selected from N, O, Si or P;
phosphorus anhydride compounds; and/or
cyclic siloxane compounds.

27. The chemical modification process according to claim 15, wherein the reaction step is implemented exclusively in the presence of the polymeric part and the flame retardant compound(s).

28. The chemical modification process according to claim 15, wherein the reaction step includes the following operations:
an operation of placing, in a first reactor, of the polymeric part, the reactor being heated to the temperature for implementing the process;
an operation of pressurising the reactor to the pressure for implementing the process;
an operation of vaporising the flame retardant compound(s) in a second reactor connected to the first reactor;
an operation of injecting the flame retardant compound(s) in the gaseous state into the first reactor;
an operation of maintaining the temperature and the pressure for implementing the process until the reaction is complete.
